(19) United States
(12) Patent Application Publication
(10) Pub. No.: US 2026/0211443 A1
(43) Pub. Date: Jul. 23, 2026

(54) LOW-POWER VOLTAGE REGULATOR CIRCUIT WITH FAST TRANSIENT RESPONSE, AND CORRESPONDING METHOD OF OPERATION

(71) Applicant: STMicroelectronics International N.V., Geneva (CH)

(72) Inventor: Rossella Gaudiano, Milano (IT)

(21) Appl. No.: 19/376,096

(22) Filed: Oct. 31, 2025

(30) Foreign Application Priority Data
Nov. 18, 2024 (IT) 102024000025884

(51) Int. Cl. G05F 3/26; G05F 1/575; G05F 1/59; G05F 3/20

(52) U.S. Cl. CPC G05F 3/262; G05F 1/575; G05F 1/59; G05F 3/205

(57) ABSTRACT

A voltage regulator has an input differential stage including a biasing current generator providing a biasing current for a biasing node, first and second input transistors coupled to the biasing node, a first cascode transistor coupled to the first input transistor at a first node, and a second cascode transistor coupled to the second input transistor at a second node. A replica transistor is between a supply node and a further node, has a gate terminal coupled to the gate terminal of an output transistor and passes a scaled-down replica current of an output current from the supply node to the further node. A current mirror coupled to the replica transistor senses the scaled-down replica current, sinks a first additional biasing current based on the scaled-down replica current from the first node, and sinks a second additional biasing current based on the scaled-down replica current from the second node.

### CROSS-REFERENCE TO RELATED APPLICATIONS

This application claims priority to Italian Application No. 102024000025884, filed on November 18, 2024, which application is hereby incorporated herein by reference.

### TECHNICAL FIELD

The description relates to low-power voltage regulator circuits, which can be implemented, for instance, in power management integrated circuits (PMIC) for use in automotive applications or other power supply applications.

### BACKGROUND

Voltage regulators with very low bias current generally have good power consumption (i.e., low consumption) but poor dynamic response to load and line transient steps (i.e., slow response).

In fact, assuming that the voltage regulator circuit is implemented with metal-oxide-semiconductor (MOS) transistors of a certain dimension (e.g., defined based on the manufacturing technology), each node of the circuit is affected by a certain parasitic capacitance that has to be charged and discharged during operation. If the current available in the circuit is low, the time needed to achieve the desired voltage operating point may be long.

In addition, a MOS transistor biased by a low current may have a worse offset compared to a MOS transistor that has the same dimensions (e.g., same area) but is biased by a higher current. Thus, larger MOS transistors may be used to achieve the desired precision (in terms of offset) without having to increase excessively the biasing current, which however results in higher parasitic capacitances.

As a consequence of the low bias current and the high parasitic capacitances, the speed achievable by the known voltage regulator circuits is generally low.

Document US 2018/0173261 A1 is exemplary of the prior art in the field of voltage regulators, as it discloses a low-dropout (LDO) voltage regulator that can adapt the level of biasing current that is provided to a differential amplifier based on the current drawn by the load. The LDO regulator comprises a differential amplifier stage, a buffer stage, an adaptive biasing stage, and an output stage. The differential amplifier stage comprises a long-tailed pair arrangement including two n-channel MOS transistors. These transistors form a differential pair and are arranged so as to produce a differential output that is passed to the buffer stage. A tail transistor acts as a current source and provides the differential amplifier stage with the minimal amount of current it requires in order to operate. Three current mirrors act as an active load that converts the output provided at the output of the differential amplifier stage to a single-ended voltage. The voltage present at that node depends on the difference between the voltages present on the gate terminals of the differential transistors. The buffer transistor is arranged as a source follower so the voltage on its source terminal follows the voltage on its gate terminal, providing a reduction in the output impedance when compared to the output impedance of the differential amplifier stage. The adaptive biasing stage includes a PMOS replica transistor, which is a physically scaled down version of the output transistor, and is coupled to an NMOS current mirror. A bias control transistor generates a current that is summed with the minimal bias current that is sunk by the tail transistor to form a total bias current that drives the differential amplifier within the error amplifier stage.

Document US 2022/0171417 A1 is also exemplary of the prior art, insofar as it discloses a voltage regulator with improved overshoot suppression. The voltage regulator comprises an output transistor to sense a load current. An attenuated replica of the load current is filtered and re-injected as additional load of the output transistor by means of a replica transistor and a filter circuit. As a consequence, the overall load current is the sum of the load current due to the regular load and the re-injected attenuated replica. In case of an overshoot event, the load current does not drop instantaneously to low or zero load current levels but rather to a fraction of the initial load current before the overshoot event. Furthermore, due to ongoing re-injection of attenuated replica, the overall load current settles on a slower time scale.

Document US 2023/0283238 A1 is also exemplary of the prior art, insofar as it discloses a biasing circuit with high current drive capability for fast settling of a biasing voltage to a stacked cascode amplifier. According to a first aspect, the biasing circuit uses transistors matched with transistors of the cascode amplifier to generate a boost current during a transition phase that changes the biasing voltage by charging or discharging a capacitor. The boost current is activated during the transition phase and deactivated when a steady-state condition is reached. According to a second aspect, the biasing circuit uses an operational amplifier in a feedback loop that forces a source node of a cascode transistor of a reference circuit, that is a scaled down replica version of the cascode amplifier, to be at a reference voltage. The high gain and high current capability of the operational amplifier, provided by isolating a high frequency signal processed by the cascode amplifier from the reference circuit, allow for a quick settling of the biasing voltage.

Document US 2019/0258282 A1 is also exemplary of the prior art, insofar as it discloses an LDO voltage regulator with a frequency-dependent resistance device for pole tracking compensation. Substantially, a feedback loop regulates the output voltage of the LDO regulator based on a reference voltage. A change in the load current results in a change in the control signal for a pass device due to the feedback loop. This change in load current is mirrored and used to scale the frequency of an oscillator. The frequency change in the oscillator is used to alter the value of a frequency-dependent resistor. The change in resistor value is used to change the location of a zero frequency. The change in the zero frequency tracks an output pole and achieves LDO stability.

Document US 2021/0389790 A1 is also exemplary of the prior art, insofar as it discloses an LDO regulator having a fast step response to abrupt load current changes. The LDO regulator has a transient detector circuit coupled to the output node, and configured to charge/discharge respective capacitors coupled to the gate terminal of the output transistor based on the detected transient.

Document US 2019/0258283 A1 is exemplary of the prior art as well, insofar as it discloses an LDO regulator that operates with uniform output frequency characteristic over a wide range of load currents. A scaled replica of the output current is sunk from the tail node of the input differential pair.

Document US 2023/0367344 A1 is also exemplary of the prior art, insofar as it discloses various architectures for LDO regulators (e.g., a cascode flipped voltage follower configuration, or split-buffer stage configurations).

Despite the developments in the field, there is a need in the art to provide improved low-power voltage regulator circuits having a very low power consumption (e.g., matching low quiescent current requirements), especially during standby operation mode (if present), and improved response to transients and/or improved stability.

### SUMMARY

An object of one or more embodiments is to contribute in providing such improved low-power voltage regulator circuits, and corresponding methods of operation.

According to one or more embodiments, such an object can be achieved by a voltage regulator circuit having the features set forth in the claims that follow.

One or more embodiments may relate to a corresponding method of operation.

The claims are an integral part of the technical teaching provided herein in respect of the embodiments.

According to an aspect of the present description, a voltage regulator circuit includes an input differential stage. The input differential stage includes: a biasing current generator configured to provide a biasing current for a biasing node; an input differential pair of transistors comprising a first input transistor and a second input transistor both coupled to the biasing node; a pair of cascode transistors including a first cascode transistor coupled to the first input transistor at a first node and a second cascode transistor coupled to the second input transistor at a second node; and an active load circuit coupled to the pair of cascode transistors. An output node of the input differential stage is provided intermediate the first cascode transistor and the active load circuit (e.g., the output node of the input differential stage is the node between the first cascode transistor and the active load circuit). The voltage regulator circuit includes an output stage including an output transistor having a conductive channel arranged between a supply node and an output node of the voltage regulator circuit. The output transistor has a gate terminal coupled to the output node of the input differential stage and is configured to pass an output current from the supply node to the output node of the voltage regulator circuit. The voltage regulator circuit includes replica transistor having a conductive channel arranged between the supply node and a further node. The replica transistor has a gate terminal coupled to the gate terminal of the output transistor and is configured to pass a scaled-down replica current of the output current from the supply node to the further node. The voltage regulator circuit includes a current mirror coupled to the replica transistor and configured to: sense the scaled-down replica current, sink from the first node a first additional biasing current based on the scaled-down replica current, and sink from the second node a second additional biasing current based on the scaled-down replica current.

One or more embodiments may thus provide a voltage regulator circuit with good response to transients, good stability and low power consumption.

According to another aspect of the present description, a method of operating a voltage regulator circuit according to one or more embodiments includes: providing a biasing current for the biasing node via the biasing current generator; passing an output current from the supply node to the output node of the voltage regulator circuit via the output transistor; passing a scaled-down replica current of the output current from the supply node to the further node via the replica transistor; and sensing the scaled-down replica current, sinking a first additional biasing current based on the scaled-down replica current from the first node, and sinking a second additional biasing current based on the scaled-down replica current from the second node, via the current mirror.

### BRIEF DESCRIPTION OF THE DRAWINGS

One or more embodiments will now be described, by way of example only, with reference to the annexed figures, wherein:

FIG. 1 is a circuit diagram exemplary of a low-power voltage regulator circuit including a loop for increasing the speed of the regulator; and

FIG. 2 is a circuit diagram exemplary of a low-power voltage regulator circuit including a loop for increasing the speed of the regulator according to one or more embodiments of the present description.

### DETAILED DESCRIPTION OF ILLUSTRATIVE EMBODIMENTS

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular configurations, structures, or characteristics may be combined in any adequate way in one or more embodiments.

The headings/references used herein are provided merely for convenience and hence do not define the extent of protection or the scope of the embodiments.

Throughout the figures annexed herein, unless the context indicates otherwise, like parts or elements are indicated with like references/numerals and a corresponding description will not be repeated for the sake of brevity.

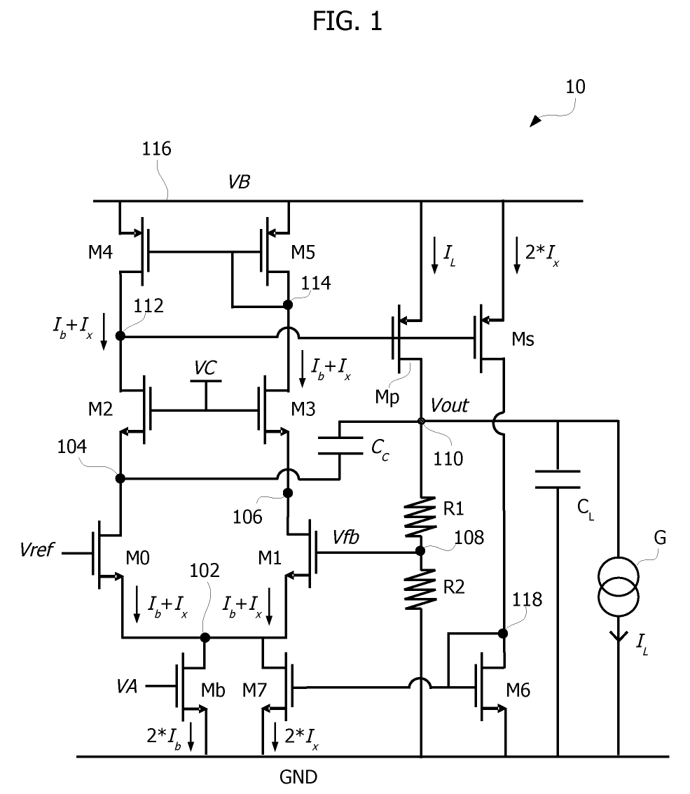

By way of introduction to the detailed description of exemplary embodiments, reference may be made to FIG. 1, which is a circuit diagram exemplary of a low-power voltage regulator circuit 10 that includes a loop for increasing the speed (e.g., response to transients) of the voltage regulator itself.

As exemplified in FIG. 1, the voltage regulator 10 includes an input differential stage and an output power stage. The input differential stage includes an input differential pair of n-channel MOS transistors (M0 and M1). In the input differential stage, the input differential pair is loaded by a pair of cascode n-channel MOS transistors (M2 and M3) and by a current mirror of p-channel MOS transistors (M4 and M5), the latter also being referred to as “active load”. In the input differential stage, the input differential pair is biased by a tail current generator that sinks a total bias current 2*I_{b}, e.g., including an n-channel MOS transistor Mb.

In particular, the input differential pair of the input differential stage may include an NMOS transistor M0 having a source terminal coupled to a node 102 (e.g., referred to as “tail node”), a drain terminal coupled to a node 104 (e.g., referred to as “compensation node”), and a gate terminal configured to receive a reference voltage Vref. The input differential pair may include an NMOS transistor M1 having a source terminal coupled to node 102, a drain terminal coupled to a node 106, and a gate terminal configured to receive a feedback voltage Vfb indicative of the output voltage Vout of the voltage regulator 10 (e.g., the gate terminal of transistor M1 may be coupled to the intermediate node 108 of a voltage divider that is arranged between the output node 110 of the regulator 10 and ground GND).

In particular, the pair of cascode transistors of the input differential stage may include an NMOS transistor M2 having a source terminal coupled to node 104 (e.g., coupled to the drain terminal of transistor M0), a drain terminal coupled to a node 112 (e.g., referred to as “output node of the input stage”), and a gate terminal configured to receive a voltage VC (e.g., a voltage reference, or fixed voltage, or constant voltage - possibly produced based on a bandgap reference). The pair of cascode transistors may include an NMOS transistor M3 having a source terminal coupled to node 106 (e.g., coupled to the drain terminal of transistor M1), a drain terminal coupled to a node 114, and a gate terminal configured to receive the voltage VC (e.g., coupled to the gate terminal of transistor M2). Therefore, transistor M2 has a conductive channel arranged in series to the conductive channel of transistor M0, and transistor M3 has a conductive channel arranged in series to the conductive channel of transistor M1.

The PMOS current mirror (or active load) of the input differential stage may be configured to sense the current sunk by the drain terminal of transistor M3 and inject a current having the same magnitude into the drain terminal of transistor M2. In particular, the PMOS current mirror may include a PMOS transistor M4 having a drain terminal coupled to node 112 (e.g., coupled to the drain terminal of transistor M2), a source terminal coupled to a node 116 that provides a supply voltage VB (e.g., referred to as “supply rail”), and a gate terminal. The PMOS current mirror may include a diode-connected PMOS transistor M5 having a drain terminal coupled to node 114 (e.g., coupled to the drain terminal of transistor M3), a source terminal coupled to node 116, and a gate terminal coupled to its drain terminal at node 114 and to the gate terminal of transistor M4. The node intermediate (e.g., between) transistor M2 and the active load circuit (e.g., transistor M4) may thus be the output node of the input differential stage.

In particular, the tail current generator of the input differential stage may include an NMOS transistor Mb having a source terminal coupled to ground GND, a drain terminal coupled to node 102, and a gate terminal configured to receive a voltage VA (e.g., a voltage reference, or fixed voltage, or constant voltage - possibly produced based on a bandgap reference). The NMOS transistor Mb may sink a tail current 2*i_{b} from node 102. With regard to the biasing of the voltage regulator 10, the tail current 2*i_{b} is equally distributed between the two branches of the input differential pair, that is, a bias current i_{b} flows through the series arrangement of transistors M0, M2 and M4, and an equal current i_{b} flows through the series arrangement of transistors M1, M3 and M5.

The output power stage of the voltage regulator 10 may include a PMOS transistor Mp having a conductive channel arranged between the supply rail 116 and the output node 110 of the voltage regulator, and a control terminal controlled by the voltage at node 112 (i.e., the output node of the input differential stage), in order to pass a load current I L from the supply rail 116 to the output node 110. In particular, transistor Mp may have a drain terminal coupled to node 110, a source terminal coupled to node 116, and a gate terminal coupled to node 112.

Furthermore, the voltage regulator 10 may include a feedback loop including a voltage divider configured to produce the feedback voltage Vfb. In particular, the feedback voltage divider may include a resistor R1 arranged between the output node 110 and the intermediate node 108, and a resistor R2 arranged between the intermediate node 108 and ground GND, so that the feedback voltage Vfb produced at node 108 is indicative of (e.g., proportional to) the regulator output voltage Vout.

Furthermore, the voltage regulator 10 may include a compensation capacitor C_{C} (e.g., to implement a Miller compensation architecture) arranged between the output node 110 of the regulator 10 and the input stage. In particular, the compensation capacitor C_{C} may have a first terminal coupled to the output node 110 and a second terminal coupled to the node 104 between transistors M0 and M2.

Furthermore, a load can be coupled to the output node 110 of the voltage regulator 10, in particular between node 110 and ground GND. The load is exemplified in FIG. 1 by a load capacitor C_{L} arranged in parallel to a current generator G between node 110 and ground GND. The load current generator sinks the load current I L from node 110. It will be understood that, despite being illustrated in FIG. 1, the load capacitor C_{L} and the load generator G are not part of the voltage regulator 10, and just serve to exemplify the effect of coupling an external load to the output node 110 of the voltage regulator 10.

In order to increase the speed (i.e., improve the response to transients) of the voltage regulator 10, a possible way is that of increasing the bias current, e.g., increasing the tail current sunk from node 102 towards ground GND. To this aim, the voltage regulator 10 exemplified in FIG. 1 includes an additional loop that includes a PMOS replica transistor configured to generate a scaled-down version of the load current /_{L}, and an NMOS current mirror configured to sense the current sourced by the drain terminal of the replica transistor and sink a current having the same magnitude from the tail node 102 of the input differential pair. In particular, the replica transistor may include a PMOS transistor Ms having a source terminal coupled to node 116, a drain terminal coupled to a node 118, and a gate terminal coupled to node 112 (i.e., coupled to the gate terminal of the power transistor Mp to receive the same control voltage). The width-to-length ratio of the replica transistor Ms may be K time smaller than the width-to-length ratio of the power transistor Mp, and in particular the width of the replica transistor Ms may be K time smaller than the width of the power transistor Mp in case the two transistors have the same length (i.e., transistors Mp and Ms are said to be in a K:1 ratio), so that the current flowing through transistor Ms is K times smaller than the current flowing through transistor Mp. Calling 2*Iₓ the total current flowing through transistor Ms, the relationship 2*Iₓ = I_{L}/K applies. The NMOS current mirror of the additional loop may include a diode-connected NMOS transistor M6 having a drain terminal coupled to node 118 (e.g., coupled to the drain terminal of the replica transistor Ms), a source terminal coupled to ground GND, and a gate terminal coupled to its drain terminal at node 118. The NMOS current mirror may include an NMOS transistor M7 having a source terminal coupled to ground GND, a drain terminal coupled to the tail node 102 of the input differential pair, and a gate terminal coupled to the gate terminal of transistor M6. The width-to-length ratio of transistor M7 may be equal to the width-to-length ratio of transistor M6, and in particular the width of the transistor M7 may be equal to the width of the transistor M6 in case the two transistors have the same length (i.e., transistors Mp and Ms are said to be in a 1:1 ratio), so that the same current 2*Iₓ flows through transistors M6 and M7. By doing so, an additional tail current 2*Iₓ is sunk from node 102, which – as far as the biasing of the voltage regulator 10 is concerned - is equally distributed between the two branches of the input differential pair, that is, an additional bias current I x flows through the series arrangement of transistors M0, M2 and M4, and an equal additional bias current I x flows through the series arrangement of transistors M1, M3 and M5, so that the total bias current flowing through each branch is equal to I_{b}+Iₓ.

The increase of the bias current achievable with the architecture exemplified in FIG. 1 is advantageous in terms of speed, because the current available to charge/discharge the parasitic capacitances is higher (with respect to architectures that do not include the additional loop of transistors Ms, M6, M7) and the transconductance of the first stage (gm₁/gm₂) increases as well, resulting in a higher gain-bandwidth product (GBWP). However, a higher gain-bandwidth product may lead to the risk of instability due to the presence of high-frequency parasitic poles in the transfer function.

It will be noted that a detailed transistor-level implementation of the voltage regulator 10 is exemplified in FIG. 1, but the same approach with an additional loop (Ms, M6, M7) configured to increase the bias current may be applied to other voltage regulator architectures.

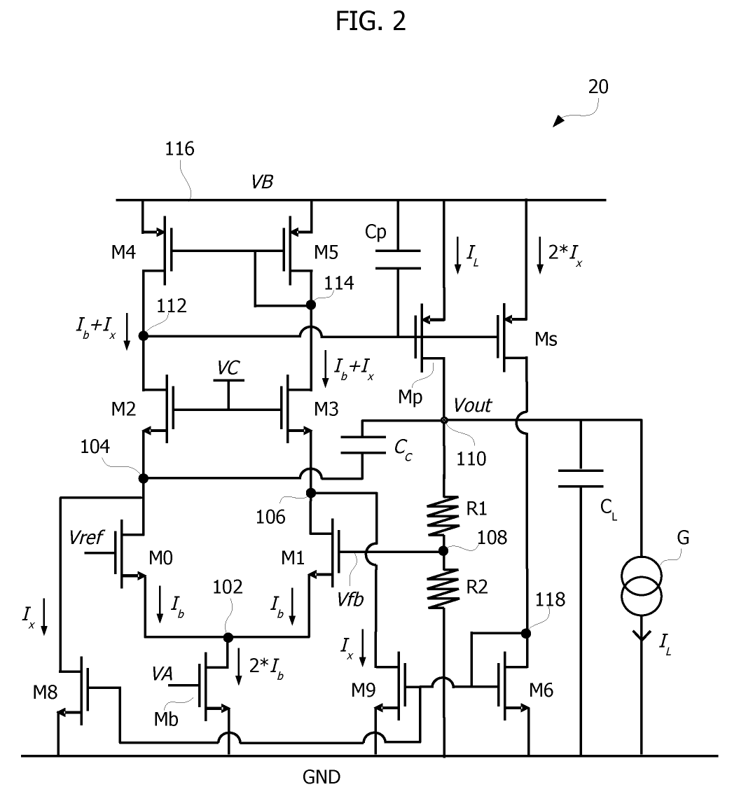

In order to achieve an increase of the bias current without worsening the performance in terms of stability, one or more embodiments may thus rely on the architecture of a voltage regulator 20 as exemplified in FIG. 2, which will be described in the following mainly by highlighting the differences with respect to the architecture of FIG. 1.

Substantially, the architecture of the voltage regulator 20 is the same as the architecture of the voltage regulator 10 as far as the input differential stage (transistors M0, M1, M2, M3, M4, M5, Mb), output stage (transistor Mp), feedback loop (divider R1, R2) and compensation capacitor (C_{C}) are concerned. In FIG. 2, just like in FIG. 1, the load capacitor C_{L} and the load generator G are illustrated to exemplify the effect of an external load coupled to node 110, but are not part of the voltage regulator 20. In FIG. 2, a parasitic capacitance Cp is indicated arranged between the gate terminal of the power transistor Mp and the supply rail 116 just for the sake of explanation: it will be understood that this capacitance does not correspond to a physical capacitor intentionally manufactured in the circuit 20, and that a similar parasitic capacitance could have been illustrated in the circuit diagram of FIG. 1 as well.

Turning now to the differences and similarities between the circuit diagram of voltage regulator 20 (FIG. 2) and the circuit diagram of voltage regulator 10 (FIG. 1), as far as the additional loop is concerned, it will be noted that the voltage regulator 20 includes the same PMOS replica transistor Ms configured to generate a scaled-down version 2*Iₓ = I_{L}/K of the load current I L, but a different NMOS current mirror. In fact, the NMOS current mirror of the architecture of FIG. 2 is configured to sense the current 2*Iₓ sourced by the drain terminal of the replica transistor Ms (with a transistor M6 just like in the architecture of FIG. 1), but has two output branches, each of which is configured to sink a current having half the magnitude (i.e., magnitude Iₓ) from a respective one of the source terminals of the cascode transistors M2 and M3. In particular, the replica transistor may include a PMOS transistor Ms having a source terminal coupled to node 116, a drain terminal coupled to node 118, and a gate terminal coupled to node 112 (i.e., coupled to the gate terminal of the power transistor Mp to receive the same control voltage). The width-to-length ratio of the replica transistor Ms may be K time smaller than the width-to-length ratio of the power transistor Mp, and in particular the width of the replica transistor Ms may be K time smaller than the width of the power transistor Mp in case the two transistors have the same length (i.e., transistors Mp and Ms are said to be in a K:1 ratio), so that the current flowing through transistor Ms is K times smaller than the current flowing through transistor Mp. Calling 2*Iₓ the total current flowing through transistor Ms, the relationship 2*Iₓ = I_{L}/K applies. The NMOS current mirror may include a diode-connected NMOS transistor M6 having a drain terminal coupled to node 118 (e.g., coupled to the drain terminal of the replica transistor Ms), a source terminal coupled to ground GND, and a gate terminal coupled to its drain terminal at node 118. In the place of a single NMOS output transistor M7 (as in FIG. 1), the NMOS current mirror may include two NMOS output transistors M8, M9. The NMOS transistor M8 may have a source terminal coupled to ground GND, a drain terminal coupled to node 104 (e.g., to the source terminal of cascode transistor M2, or in other words to a node intermediate transistors M0 and M2), and a gate terminal coupled to the gate terminal of transistor M6. The NMOS transistor M9 may have a source terminal coupled to ground GND, a drain terminal coupled to node 106 (e.g., to the source terminal of cascode transistor M3, or in other words to a node intermediate transistors M1 and M3), and a gate terminal coupled to the gate terminal of transistor M6. The width-to-length ratio of transistors M8 and M9 may be half of the width-to-length ratio of transistor M6, and in particular the width of transistors M8 and M9 may be half of the width of transistor M6 in case the three transistors have the same length (i.e., transistors M8 and M9 are said to be in a 2:1 ratio with transistor M6), so that a current I x flows through transistors M8 and M9 if a current 2*Iₓ flows through transistor M6. By doing so, an additional current I x is sunk from each of nodes 104 and 106, so that - as far as the biasing of the voltage regulator 10 is concerned - a current I_{b}+Iₓ flows through transistors M2 and M4 as well as through transistors M3 and M5, and a current I_{b} flows through each of the transistors M0 and M1 of the input differential pair.

It will otherwise be noted that in one or more embodiments the width-to-length ratios of transistors M6, M8 and M9 may be different from the 2:1:1 relationship described above, as long as the transistors M8 and M9 have the same width-to-length ratio amongst themselves and thus sink the same amount of current from nodes 104 and 106, respectively. For instance, the width-to-length ratio of transistors M8 and M9 may be a quarter of the width-to-length ratio of transistor M6, so that a current Iₓ/2 flows through transistors M8 and M9 if a current 2*I ₓ flows through transistor M6. By doing so, an additional current Iₓ/2 is sunk from each of nodes 104 and 106, so that – as far as the biasing of the voltage regulator 10 is concerned - a current I_{b}+Iₓ/2 flows through transistors M2 and M4 as well as through transistors M3 and M5, and a current I_{b} flows through each of the transistors M0 and M1 of the input differential pair. According to a further example, the width-to-length ratio of transistors M8 and M9 may be equal to the width-to-length ratio of transistor M6, so that a current 2*Iₓ flows through transistors M8 and M9 if a current 2*Iₓflows through transistor M6. By doing so, an additional current 2*Iₓ is sunk from each of nodes 104 and 106, so that i as far as the biasing of the voltage regulator 10 is concerned - a current I_{b}+2*Iₓ flows through transistors M2 and M4 as well as through transistors M3 and M5, and a current I_{b} flows through each of the transistors M0 and M1 of the input differential pair.

More generally, it will be understood that each of transistors M8 and M9 sinks a current (from nodes 104 and 106, respectively) having a magnitude that is a based on (e.g., it is a function of, and in particular is half of) the magnitude of the current 2*Iₓ that flows through transistor M6.

With the architecture exemplified in FIG. 2, it is possible to increase the bias current by adding a scaled replica Iₓ of the load current I_{L} at the source terminal of each of the cascode transistors M2 and M3, thereby improving the speed but avoiding instability. During a low-to-high step of the load current I_{L} the output voltage Vout would exhibit an undershoot but, thanks to the compensation capacitor C_{C}, an extra current is available to charge very fast the gate (parasitic) capacitance Cp of the power transistor Mp, increasing the gate-source voltage (Vgs) of transistor Mp and thus its current capability in order to react to the undershoot. On the other hand, during a high-to-low step of the load current I_{L}, the output voltage Vout would exhibit an overshoot but, thanks to the compensation capacitor C_{C}, the cascode transistor M2 is switched off very fast and the gate capacitance Cp of the power transistor Mp is discharged via transistor M4, which can source a current I_{b}+Iₓ to the gate of transistor Mp (at node 112). The higher the current flowing through transistor M4, the faster the reaction.

In the architecture of FIG. 2, since the bias current flowing through the input pair of transistors M0 and M1 remains the same (compared to the architectures that do not include the additional loop), the gain-bandwidth product also does not change, avoiding the risk of instability but keeping, at the same time, the benefit of the improved speed during transient response. Thus, in other words, the architecture of FIG. 2 is faster compared to architectures that do not include an additional biasing loop, and is more stable compared to the architecture of FIG. 1, which includes an additional biasing loop coupled to the tail node 102 of the input differential pair.

One or more embodiments may thus provide a voltage regulator circuit that is at the same time fast (i.e., has good response to transients) and stable.

It will be noted that one or more embodiments have been described with reference to FIGS. 1 and 2, including NMOS transistors for the tail current generator, input differential pair, cascode transistors and current mirror in the additional biasing loop, and including PMOS transistors for the active load, output power transistor, and replica transistor. It will be understood that in different embodiments, a similar architecture of the additional biasing loop can be applied to a voltage regulator having a complementary structure (e.g., having an input differential pair of PMOS transistors).

Without prejudice to the underlying principles, the details and embodiments may vary, even significantly, with respect to what has been described by way of example only, without departing from the extent of protection.

The extent of protection is determined by the annexed claims.

What is claimed is:

1. A voltage regulator circuit, comprising:
an input differential stage comprising:
a biasing current generator configured to provide a biasing current for a biasing node;
an input differential pair of transistors comprising a first input transistor and a second input transistor, both coupled to the biasing node;
a pair of cascode transistors comprising a first cascode transistor coupled to the first input transistor at a first node, and a second cascode transistor coupled to the second input transistor at a second node; and
an active load circuit coupled to the pair of cascode transistors, wherein an output node of the input differential stage is intermediate the first cascode transistor and the active load circuit;
an output stage comprising an output transistor having a conductive channel disposed between a supply node and an output node of the voltage regulator circuit, the output transistor having a gate terminal coupled to the output node of the input differential stage, and configured to pass an output current from the supply node to the output node of the voltage regulator circuit;
a replica transistor having a conductive channel between the supply node and a further node, the replica transistor having a gate terminal coupled to the gate terminal of the output transistor, and configured to pass a scaled-down replica current of the output current from the supply node to the further node; and
a current mirror coupled to the replica transistor, and configured to sense the scaled-down replica current, sink from the first node a first additional biasing current based on the scaled-down replica current, and sink from the second node a second additional biasing current based on the scaled-down replica current.

2. The voltage regulator circuit of claim 1, wherein the current mirror comprises:
a diode-connected transistor coupled between the replica transistor and a ground;
a first current-sinking transistor coupled between the first node and the ground, and having a gate terminal coupled to the gate terminal of the diode-connected transistor; and
a second current-sinking transistor coupled between the second node and the ground, and having a gate terminal coupled to the gate terminal of the diode-connected transistor.

3. The voltage regulator circuit of claim 2, wherein a width-to-length ratio of the first current-sinking transistor and of the second current-sinking transistor is half of a width-to-length ratio of the diode-connected transistor.

4. The voltage regulator circuit of claim 1, further comprising a compensation capacitor disposed between the output node of the voltage regulator circuit and the first node.

5. The voltage regulator circuit of claim 1, wherein the biasing current generator comprises a biasing transistor having a gate terminal configured to receive a first fixed voltage.

6. The voltage regulator circuit of claim 1, wherein the first input transistor has a gate terminal configured to receive a reference voltage, and the second input transistor has a gate terminal configured to receive a feedback voltage indicative of an output voltage of the voltage regulator circuit.

7. The voltage regulator circuit of claim 1, wherein the first input transistor has a source terminal coupled to the biasing node and a drain terminal coupled to the first node, and the second input transistor has a source terminal coupled to the biasing node and a drain terminal coupled to the second node.

8. The voltage regulator circuit of claim 1, wherein:
the first cascode transistor has a source terminal coupled to the first node, a drain terminal coupled to the output node of the input differential stage, and a gate terminal configured to receive a second fixed voltage; and
the second cascode transistor has a source terminal coupled to the second node, a drain terminal coupled to a third node, and a gate terminal configured to receive the second fixed voltage.

9. The voltage regulator circuit of claim 8, wherein the active load circuit comprises:
a first active load transistor having a source terminal coupled to the supply node, a drain terminal coupled to the output node of the input differential stage, and a gate terminal; and
a diode-connected second active load transistor having a source terminal coupled to the supply node, a drain terminal coupled to the third node, and a gate terminal coupled to its drain terminal and to the gate terminal of the first active load transistor.

10. A method of operating a voltage regulator circuit comprising an input differential stage having a biasing current generator, an input differential pair of transistors comprising a first input transistor and a second input transistor, both coupled to a biasing node of the biasing current generator, and a pair of cascode transistors comprising a first cascode transistor coupled to the first input transistor at a first node, and a second cascode transistor coupled to the second input transistor at a second node, the voltage regulator circuit further comprising an output stage comprising an output transistor having a conductive channel disposed between a supply node and an output node of the voltage regulator circuit, a replica transistor having a conductive channel between the supply node and a further node, and a gate terminal coupled to the gate terminal of the output transistor, and a current mirror coupled to the replica transistor, the method comprising:
providing, by the biasing current generator, a biasing current to the biasing node;
passing, by the output transistor, an output current from the supply node to the output node of the voltage regulator circuit;
passing, by the replica transistor, a scaled-down replica current of the output current from the supply node to the further node;
sensing, by the current mirror, the scaled-down replica current;
sinking, by the current mirror, a first additional biasing current from the first node, based on the scaled-down replica current; and
sinking, by the current mirror, a second additional biasing current from the second node, based on the scaled-down replica current.

11. The method of claim 10, further comprising providing, by an active load circuit, an active load for the pair of cascode transistors, an output node of the input differential stage being intermediate the first cascode transistor and the active load circuit.

12. The method of claim 11, wherein the first cascode transistor has a source terminal coupled to the first node and a drain terminal coupled to the output node of the input differential stage, the second cascode transistor has a source terminal coupled to the second node and a drain terminal coupled to a third node, and the method further comprises:
receiving, by a gate terminal of the first cascode transistor, a second fixed voltage; and
receiving, by a gate terminal the second cascode transistor, the second fixed voltage.

13. The method of claim 12, further comprising:
providing, by a first active load transistor of the active load circuit, a source terminal coupled to the supply node, a drain terminal coupled to the output node of the input differential stage, and a gate terminal; and
providing, by a diode-connected second active load transistor of the active load circuit, a source terminal coupled to the supply node, a drain terminal coupled to the third node, and a gate terminal coupled to its drain terminal and to the gate terminal of the first active load transistor.

14. The method of claim 10, further comprising providing, by the output transistor, a gate terminal coupled to the output node of the input differential stage.

15. The method of claim 10, further comprising:
providing a diode-connected transistor coupled between the replica transistor and a ground;
providing, by a first current-sinking transistor coupled between the first node and the ground, a gate terminal coupled to the gate terminal of the diode-connected transistor; and
providing, by a second current-sinking transistor coupled between the second node and the ground, a gate terminal coupled to the gate terminal of the diode-connected transistor.

16. The method of claim 15, wherein a width-to-length ratio of the first current-sinking transistor and of the second current-sinking transistor is half of a width-to-length ratio of the diode-connected transistor.

17. The method of claim 10, further comprising providing a compensation capacitance between the output node of the voltage regulator circuit and the first node.

18. The method of claim 10, further comprising receiving, by a gate terminal of a biasing transistor of the biasing current generator, a first fixed voltage.

19. The method of claim 10, further comprising
receiving, by a gate terminal of the first input transistor, a reference voltage; and
receiving, by a gate terminal of the second input transistor, a feedback voltage indicative of an output voltage of the voltage regulator circuit.

20. The method of claim 10, further comprising:
providing, by the first input transistor, a source terminal coupled to the biasing node and a drain terminal coupled to the first node; and
providing, by the second input transistor, a source terminal coupled to the biasing node and a drain terminal coupled to the second node.
